(19) United States
(12) Patent Application Publication
(10) Pub. No.: US 2004/0202528 A1
(43) Pub. Date: Oct. 14, 2004

(54) Paper button

(76) Inventor: Gilbert Roman, Franklin Pk, NJ (US)

Correspondence Address: Gilbert Roman, 22 Amberly Ct., Franklin Pk, NJ, 08823, US

(21) Appl. No.: 10/330,933

(22) Filed: Apr. 14, 2003

(51) Int. Cl. F16B 15/00

(52) U.S. Cl. 411/457

(57) ABSTRACT

The Paper Button is a paper fastening tool. All documents needing to be fastened could be easily. My invention has a hole in the middle allowing it to fastened and be held in: loose leaf and spiral note books, medical folders, cork boards, report folders; these being some of the main applications.

### DRAWINGS

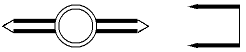

You can see a front and side view of the Paper Button. The invention will be made of a soft flexable metal, allowing it to fasten documents together. The prongs will penetrate the documents needing to be fastened; then they will be opened securing one side of the document. The oval part will be large enough to secure a standard sized holed paper.

### SPECIFICATIONS

The paper button is a paper fastening device. The paper button binds papers and secures them until utilized. The round oval side secures one side; while the prong side secures the other side. Possible uses: Schools, Businessess, Medical Offices, etc.

### RELATED ART

You shall find a front and side view of the paper button. The round oval side will secure one side of the document needing to be secured. The pronged side will penitrate and secure the other side needing to be binded; by separating the prongs.

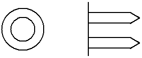

1. I claim that I am the sole inventor of the Paper Button. I have no knowledge of any other invention of this type. My invention will fasten holed and un-holed documents in a secure manner. It will be held in: loose leaf and spiral note books, medical folders, cork boards and report folders. The Paper Button allows penetration by certain items because of the hole in the middle. I Gilbert Roman claim this as my invention.
